(19) United States
(12) Patent Application Publication
(10) Pub. No.: US 2009/0288074 A1
(43) Pub. Date: Nov. 19, 2009

(54) RESOURCE CONFLICT PROFILING

(75) Inventors: Steven M. Carroll, Sammamish, WA (US); John A. Cunningham, Kirkland, WA (US); Richard T. Wurdack, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/120,233

(22) Filed: May 14, 2008

(51) Int. Cl. G06F 9/45

(52) U.S. Cl. 717/158

(57) ABSTRACT

Analyzing usage patterns of resources by various execution contexts (such as threads) may be difficult due to the volume of information that may be involved. A profiling technique may focus on the detection of resource requests that result in a resource conflict, e.g., a request for access to a resource that is exclusively in use by another resource. The profiling may then involve identifying the user action associated with the execution context that caused the resource conflict (e.g., via a stack walk) and the resource utilized, measuring the delay in the fulfillment of the request, and recording the information in a resource conflict log. The resource requests that are captured and recorded in this manner may be constrained to the information that is helpful in identifying performance bottlenecks and usage patterns, which may lead to redesigned applications of greater performance while interfacing with execution contexts, and vice versa.

### BACKGROUND

Many contemporary computing environments involve the concurrent execution of multiple applications, comprising one or more execution contexts (threads, processes, tasks, compiled or interpreted applications, scripts, etc.) that process user actions (e.g., instructions embedded in an application binary, requests generated by a user through a user interface for the execution context, etc.) in furtherance of the tasks of the application. These execution contexts may utilize computing resources of many kinds, such as user data files, multimedia objects, hardware and hardware drivers, wholly and partially compiled assemblies, code libraries, and application programming interfaces (APIs.) Some resources may be concurrently used by several execution contexts; e.g., many execution contexts may concurrently utilize a memory management application programming interface to request and administrate blocks of memory belonging to the applications. However, other resources may be difficult to utilize by a large number of concurrent objects; e.g., a user data file that is concurrently modified by many applications (in the absence of a technique for concurrent access) may exhibit data loss or corruption, deadlocks, or diminished performance. The conflicting use of such resources by multiple execution contexts may result in undesirable consequences.

In order to mitigate the consequences of resource conflicts with respect to a particular resource, the computing environment may protect the resource, such as by providing a concurrent access construct. As a first example, access to the resource may be directed through a semaphore, which may accept requests from execution contexts to interact with the resource and may extend or withhold access permission according to the access privileges extended to other execution contexts. In one such embodiment, the semaphore may be configured to restrict the resource to exclusive access by one execution context at a time, and may grant access permission to a requesting execution context only when no other execution contexts are concurrently accessing the object. An execution context may request access to the resource in a synchronous manner (wherein the execution context is blocked, or suspended, until access permission is granted) and/or in an asynchronous manner (wherein the execution context is permitted to continue executing while the request is pending, and may be notified when access is subsequently granted.)

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

An execution context that interacts with one or more protected computing resources may exhibit diminished performance, such as extensive memory usage or frequent and/or protracted execution delays, due to the negotiation of access permissions with the computing environment. In some cases, it may be difficult to determine the cause, frequency, or duration of delays in obtaining access requests, such as with respect to an execution context that interacts with many resources, or many execution contexts that cooperatively or competitively utilize a resource. If the resource conflicts encountered by an execution context are difficult to ascertain, application developers may be unable to identify which user actions (e.g., an instruction embedded in the code of the execution context, a user action invoked through a user interface of the execution context, etc.) caused a performance issue, or to design an alternative access technique that may improve the operation of one or more applications.

Accordingly, it may be desirable to record the resource conflicts generated by the interactions of various execution contexts with user actions that may specify requests for various resources. For example, a code profiler may be developed that detects and documents the flow of an execution context and the sequence of execution context user actions that generate requests and responses. However, if the execution context interacts frequently with many objects, the output may be voluminous, and it may be difficult to determine which requests result in resource conflicts or how significantly the resource conflicts impact the performance of the application. Conversely, it may not be feasible to record accesses of a heavily utilized resource. Also, in some scenarios, the requests to utilize a resource may be processed through a messaging queue that may obscure the identity of the execution context issuing the request, and it may be not be feasible to attempt to identify every execution context that issues access requests with respect to the resource.

An alternative technique for profiling, analyzing, and/or documenting resource conflicts among execution contexts and resources involves applying the resource conflict analysis only to requests that result in a resource conflict. For example, if a frequently used resource (such as a memory management module) is accessed one thousand times in one second, it may be advantageous to detect and profile the use of the resource only in the event of a resource conflict, such as a delay in handling a request for memory while the module handles a pending request by another execution context. Accordingly, techniques may be devised for detecting resource conflicts, measuring circumstances of the scenario in which the resource conflict has arisen (e.g., the identity of the calling execution context and the resource utilized, and the duration of the delay in handling the request due to the resource conflict) and recording the details thereof, such as in a resource conflict data store. The documenting of resource conflicts in this manner may be helpful in determining performance bottlenecks relating to the utilization of resources and achieving improved system performance.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary use of a resource by various execution contexts that results in a resource conflict, and a documentation thereof.

FIG. 2 is a flow chart illustrating an exemplary method of documenting a resource conflict relating to a resource.

FIG. 3 is a component block diagram illustrating an exemplary system for documenting a resource conflict relating to a resource.

FIG. 4 is a component block diagram illustrating another exemplary system for documenting a resource conflict relating to a resource.

FIG. 5 is a component block diagram illustrating yet another exemplary system for documenting a resource conflict relating to a resource.

FIG. 6 is a flow chart illustrating another exemplary method of documenting a resource conflict relating to a resource.

FIG. 7 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

Modern computing environments operate in an environment comprising various resources, such as system hardware components (e.g., processors and system buses), memory (e.g., system memory modules and storage devices), peripherals (e.g., cameras and printers), and software components (e.g., network drivers and data query processing interfaces.) Applications are often devised that make use of such resources, such as by requesting memory to store data, sending a print job to a printer, and queuing a datagram for transmission by a network adapter. The computing environment may therefore expose one or more interfaces to the resources, such that an execution context (such as a thread, a process, a task, a compiled or interpreted application, a script, etc.) may submit a request pertaining to a resource (e.g., an allocation of a memory segment of a particular size.) By providing various interfaces to such resources for use by application execution contexts, the computing environment may present a computing platform upon which many applications may concurrently operate with safe sharing of the resources so exposed.

However, the computing environment may extend safeguards over certain resources to avoid problems arising from concurrent use of the resource. For example, if two execution contexts concurrently read to and write from a data store without cooperation, data may be lost due to write-after-read (WAR) hazards. Therefore, computing environments often protect resources with a concurrent access control mechanism. As a first example, a resource may be concurrently readable by many execution contexts, but may be writable only by one execution context at a time, and execution contexts that have been granted read access may be notified when an execution context with write access alters the source data. As a second example, requests by execution contexts to utilize a resource may be queued, and the computing environment may handle the requests in sequence to reduce hazards arising from the concurrent handling of multiple requests.

Many techniques for providing cooperative, concurrent access to a resource may involve a resource lock, wherein the handling of one request to use a resource may be delayed while the computing environment processes another request to use the resource that was queued earlier, or that has been designated as of higher priority. However, the performance of the application may be reduced as a result of the delay, particularly if the delay is lengthy, or if the application utilizes many such resources and experiences many such delays. Moreover, if the application is not configured to anticipate the delay (e.g., if a particular type of request is delayed only in rare circumstances), the application may not handle the delay well, and may crash or exhibit timeouts in various processes.

A developer may therefore wish to determine the sources of delay in an application that exhibits diminished performance, or in a resource that generates many resource conflicts, and may seek to capture information about the requests issued to the resource and the performance thereof. The captured information, representing a profile of the usage of resources requested by one or more user actions associated with one or more execution contexts, may be used to examine the frequency, sequence, and details of resources utilized by an application, which may be helpful in redesigning the application to reduce performance bottlenecks.

However, for various reasons, it may be difficult to analyze the usage patterns of a resource reflected by a capturing of resource requests. As a first example, if an application frequently utilizes a resource (e.g., a high-powered graphics application that heavily utilizes a graphics resource, such as a display adapter), the information generated during the usage may be so voluminous as to obscure the details of the requests that gave rise to performance delays. As a second example, if many applications concurrently utilize a resource, it may be difficult to determine which execution context issued which request, particularly if the execution contexts utilize a common interface for communicating with the resource. For instance, a memory management module may be configured to allocate memory on behalf of many execution contexts, but the execution contexts may communicate with the memory management module through an application programming interface (API). The captured requests may therefore appear to issue from the API, and it may be difficult to determine which execution context the API was servicing in making a particular request. This determination may involve complicated call tracing, such as a stack walk, which may not be feasible to execute for the many requests issued to the resource during ordinary usage.

An alternative technique for profiling the usage of resources by execution contexts may be devised that limits the amount of captured information to the information that may be useful. The limitation involves detecting whether a particular resource request results in a resource conflict, and then recording the details of the resource request. If a resource request results in a resource conflict, the computing environment may endeavor to identify the conflicted resource and the user action executed by the execution context that caused the resource conflict. The computing environment may also determine the duration of the conflict, which may represent the duration of delay and loss of performance caused by the resource conflict. The computing environment may then record this information in a manner that a developer may analyze, e.g., a resource conflict data store. In this manner, a profile of resource utilization may be generated during a realtime execution of one or more execution contexts that is limited to the conflict-generating resource requests that may be of interest to a developer. Moreover, the more complicated elements of this technique (e.g., the identification of the execution context, which may involve a stack walk) may be invoked only where the information provided (in this case, the identity of the resource-requesting execution context) may be helpful to record, rather than expending computing cycles in identifying resource-requesting execution contexts in the absence of a resource conflict.

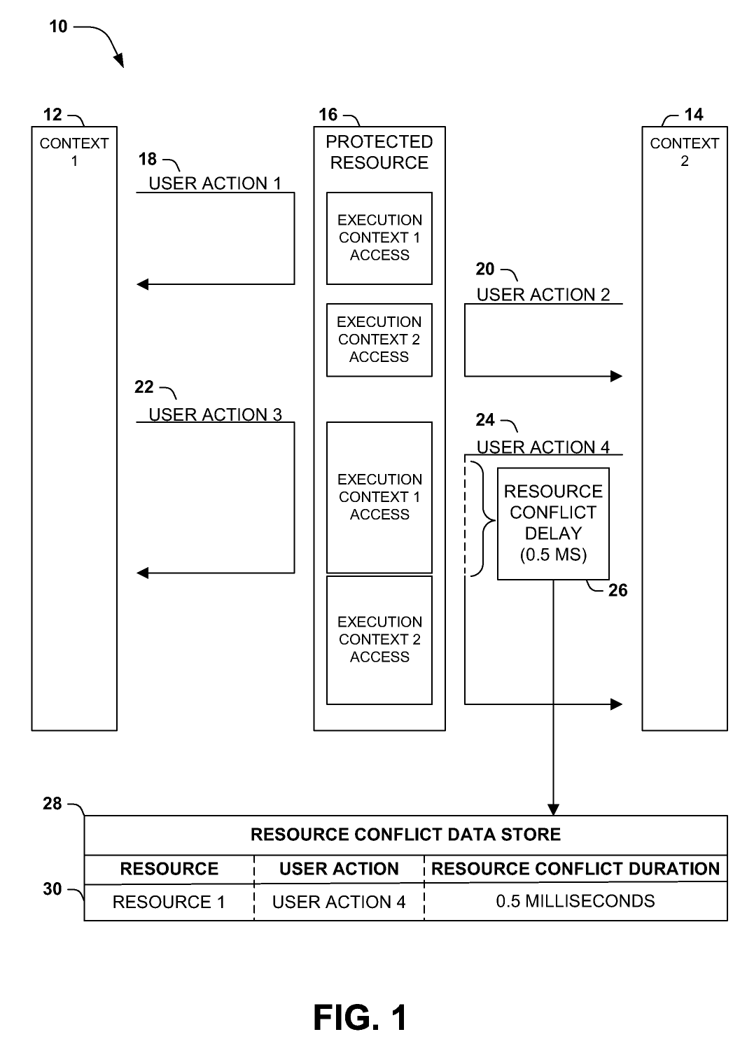

FIG. 1 illustrates an exemplary scenario 10 to which the technique may be applied. In this exemplary scenario 10, a first execution context 12 and a second execution context 14 utilize a protected resource 16, e.g., a data file that may only be accessed by one execution context at a time. It may be appreciated that the vertical axis of this figure represents a progressive timeline whereby the events of the exemplary scenario 10 arise. The exemplary scenario 10 begins with a first user action 18 by the first execution context 12 that requests to utilize the protected resource 16. Since the protected resource 16 is not in use when the request raised by the first user action 18 is received, the protected resource 16 grants exclusive access to the first execution context 12, which uses the protected resource 16 and completes its access, thereby releasing its exclusive rights to the protected resource 16. Subsequently, the second execution context 14 generates a second user action 20 requesting to utilize the protected resource 12, which again grants exclusive access to the second execution context 14. The second execution context 14 completes its access of the protected resource 16 and releases its exclusive lock on the protected resource 16. However, within the first execution context 12 arises a third user action 22 that requests to utilize the resource, and while the computing environment is extending such access to the first execution context 12, the second execution context 14 executes a fourth user action 24 requesting access to the protected resource 16. In this exemplary scenario 10, a response to the request raised by the fourth user action 24 is delayed until the third user action 22 is fulfilled, after which the fourth user action 24 is completed and the second execution context 14 is granted access to the protected resource. The delay in the response of the computing environment to the second execution context 14 represents a resource conflict. In this exemplary scenario 10, the computing environment detects the resource conflict and attempts to identify the conflicted protected resource 16 and the second execution context 14 that invoked the conflict-generating fourth user action 24. The computing environment also records the resource conflict delay 26, e.g., by timing the interval between the execution of the fourth user action 24 and the acceptance of the request raised by the fourth user action 24. This information may then be stored, e.g. in a resource conflict data store 28, where the resource conflict may be documented as a resource conflict record 30 comprising the identity of the protected resource 16, the identity of the user action within the second execution context 14 that initiated the conflict-generating resource request, and the duration of the resource conflict delay 26.

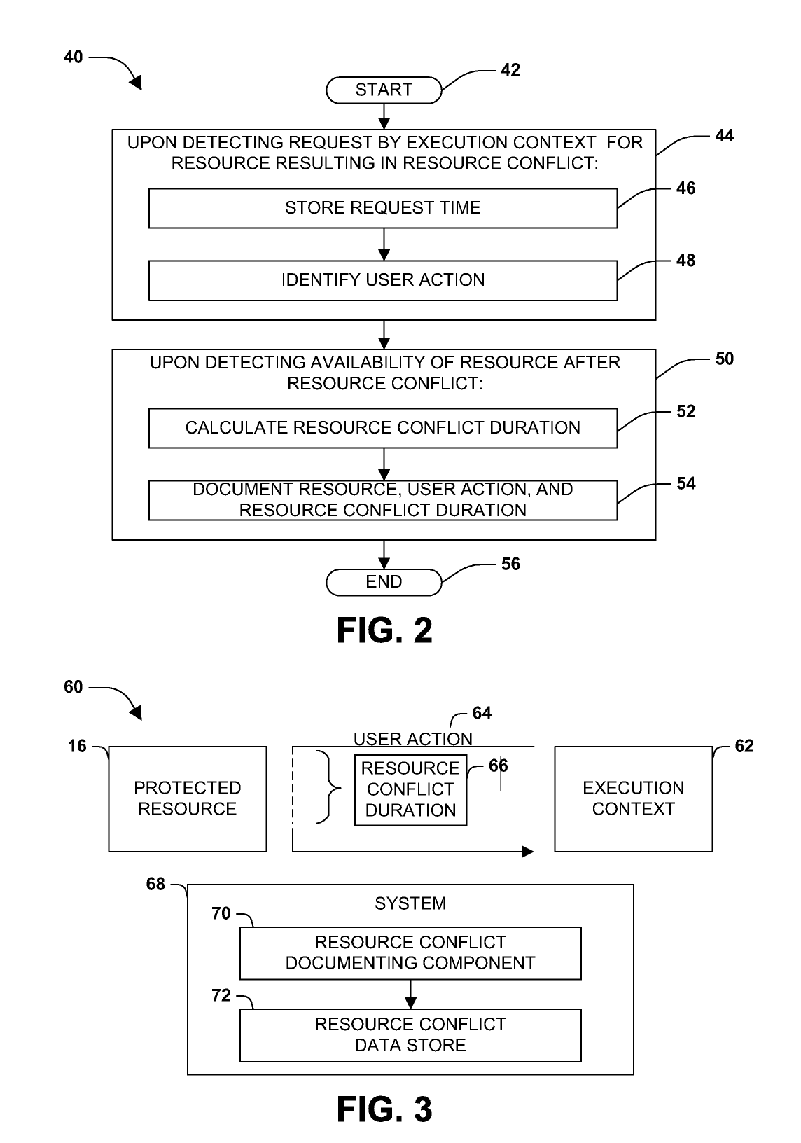

FIG. 2 illustrates a first embodiment of this technique, comprising an exemplary method 40 of documenting a resource conflict relating to a resource, which may arise from a request for the resource generated by an execution context. The exemplary method 40 begins at 42 and involves detecting 44 a request by an execution context for the resource that results in a resource conflict. Upon detecting 44 such a request, the exemplary method 40 involves storing 46 a request time (such as the timestamp of the request, the time reported by the resource upon receiving the request, or the time at which the computing environment recognizes a resource conflict) and identifying 48 the user action executed by the execution context that caused the resource conflict (e.g., by executing a stack walk on the execution context to which the request belongs, and then identifying the user action executed by the execution context that resulted in the resource conflict.) After detecting 44 the resource conflict generating request, the exemplary method 40 involves detecting 50 availability of the resource after the resource conflict, such as may arise when the resource becomes available and the resource conflict has dissipated. Upon detecting 50 the subsequent availability of the resource and the conclusion of the resource conflict, the exemplary method 40 involves calculating 52 a resource conflict duration (e.g., by subtracting the request time from the current system time.) The exemplary method 40 then involves documenting 54 the resource, the user action, and the resource conflict duration, such as in a resource conflict data store. Having achieved the recording of the circumstances under which the resource conflict arose and the duration thereof, the exemplary method 40 thereby achieves the documenting of the resource conflict, and so ends at 56.

FIG. 3 illustrates a second embodiment of this technique, comprising an exemplary system 68 for documenting resource conflicts relating to at least one protected resource 16. In this figure, the exemplary system 68 is illustrated as operating within an exemplary scenario 60 involving an execution context 62 that executes a user action comprising a request 64 to the protected resource 16 that results in a resource conflict (e.g., a pending request for access to an object that is initiated during an exclusive use of the object by another execution context.) The exemplary system 68 includes a resource conflict data store 72, which is configured to store records of resource conflicts involving the resource 16, the user action 62 requesting the resource 16 that resulting in a resource conflict, and a resource conflict duration 66. The exemplary system 68 also includes a resource conflict documenting component 70, which is configured to detect a request 64 by a user action within an execution context 62 for a protected resource 16 that results in a resource conflict. Upon detecting such a request 64, the resource conflict documenting component 70 is configured to store a request time and to identify the user action executed by the execution context 62 (e.g., through a stack walk.) The resource conflict documenting component 70 is also configured to detect availability of the protected resource 16 after the resource conflict. Upon detecting such availability, the resource conflict documenting component 70 is configured to calculate the resource conflict duration 66, and to create a resource conflict record in the resource conflict data store 72, including the resource, the user action, and the resource conflict duration. Having achieved the recording of the circumstances of the resource conflict record arising from the request 64 embodied in the user action executed by the execution context 62 to the protected resource 16, the exemplary system 68 thereby achieves the documenting of the resource conflict.

The techniques described herein may vary in certain aspects, and some variations may present additional advantages and/or reduce disadvantages with respect to other variations of these and other techniques. Such variations may be included in various forms of embodiments (such as the exemplary method 40 of FIG. 2, and/or the exemplary system 68 of FIG. 3.) Moreover, these variations may be implemented alone or together with other variations of various aspects, and some combinations may result in compatible and/or synergistic combinations of additional advantages and/or reduced disadvantages.

A first aspect that may vary among implementations of these techniques relates to the scenario in which the techniques are utilized. As a first example, described with reference to FIG. 3, the request 64 issued by the execution context 62 may be a synchronous, blocking resource request, wherein the operation of the execution context 62 is suspended until the request is granted by the protected resource 16. This type of request 64 may be advantageous where the execution context may be unable to make further progress until the request 64 is granted and the protected resource 16 may be accessed. For example, a double-buffered graphics application may prepare a graphics frame for delivery to a display adapter. Until the display adapter (operating as the protected resource) accepts the prepared graphics frame, the graphics application may be unable to initiate preparation of the next graphics frame, as this may involve erasing the contents of the buffer to begin drawing the next graphics frame. Alternatively, the request 64 issued by the execution context 62 may be an asynchronous, non-blocking resource request, wherein the execution context 62 may initiate the request 64 but may continue to perform useful work while the request is pending and before the request is granted. The execution context 62 may subsequently receive notice of the granting of the request 64 in various manners (e.g., by polling the protected resource 16 with respect to the status of the request 64, or by providing an asynchronous callback that the protected resource 16 may invoke when the request 64 is granted.) For example, a triple-buffered graphics application may prepare a graphics frame for delivery to the display adapter in a first buffer, and instead of waiting for the graphics adapter to respond and complete the acceptance of the first buffer, the graphics application may begin work on a second graphics frame stored in a second buffer. When the graphics adapter responds that it has completed the acceptance of the first buffer, the graphics application may respond by flagging the first buffer as available for rendering a third graphics frame after the second graphics frame has been prepared and is awaiting delivery to the display adapter. Those of ordinary skill in the art may devise many types of resource requests that may be profiled according to the techniques discussed herein.

As a second variation of this first aspect, the techniques discussed herein may be applied to document many types of resource conflicts. In a first scenario, such as illustrated in FIG. 1, the protected resource 16 may be shared among at least two execution contexts, and the sharing may be mediated by an access sharing construct (e.g., a mechanism for granting exclusive access to one execution context at a time.) The concurrent access construct may comprise, e.g., a semaphore, whereby execution contexts communicate their interactions with the protected resource 16 through a shared data object; a critical section, whereby a certain set of user actions that pertain to the protected resource 16 is designated as exclusively executed by one execution context at a time; and/or a monitor, whereby a management object is devised to queue and process requests by various execution contexts to access the protected resource 16. In this first scenario, the resource conflict comprises a request for the protected resource 16 by one execution context (e.g., the second execution context 14) during a resource access by another execution context (e.g., the first execution context 12.) In a second scenario, the resource conflict may involve a request issued by an execution context for a resource at an inopportune moment, e.g., a request for an allocation of space on a disk while the computing environment is performing a defragmentation of the disk. In a third scenario, the resource conflict may involve a request by a user action associated with an execution context that is formulated in such a way as to be inherently difficult for the computing environment to fulfill; e.g., a request for a large block of system memory may prompt the computing environment to compact memory and move other applications, whereas a series of requests for smaller segments of non-contiguous memory may be more quickly fulfilled. Those of ordinary skill in the art may be able to identify many types of resource conflicts through analysis according to the techniques discussed herein.

A second aspect that may vary among implementations of these techniques relates to the manner of detecting 44 a request by a user action associated with an execution context that results in a resource conflict. As a first example, the detecting 44 may arise where a resource request is issued to a resource, but is not fulfilled within a certain period of time. The request may be monitored by the computing environment (e.g., as part of an API that interfaces with the protected resource) or by an embodiment of these techniques (e.g., the exemplary system 68 of FIG. 3.) This example might be implemented within the computing environment as a publication model, wherein execution contexts may subscribe to a resource conflict event to receive notifications from the computing environment that such events have been detected. Alternatively or additionally, this example might be implemented via communication through an event log, which other execution contexts (such as the exemplary system 68 of FIG. 3) may read to determine the existence of resource conflicts. As a second example, the detecting 44 may arise if the resource indicates that a resource conflict exists, e.g., through a status indicator associated with the protected resource that is updated to indicate the existence of a resource conflict (e.g., an exclusively allocated access of the protected resource while at least one other access request is pending.) The status indicator may then be polled after issuing a request to determine whether the request has resulted in a resource conflict. As a third example, the detecting 44 may arise where the resource may answer queries as to whether a subsequent request may generate a resource conflict. For instance, in addition to handling resource requests, a particular resource may be queried as to its availability (e.g., an IsAvailable( ) method), and the results may be utilized to determine whether a request that an execution context has generated will or will not generate a resource conflict upon communication to the protected resource. Those of ordinary skill in the art may devise many ways of detecting resource conflicts in accordance with the techniques discussed herein.

A third aspect that may vary among implementations of these techniques relates to the manner of identifying the user action, such as in FIG. 2, where the identifying 48 occurs upon detecting 44 a resource request by a user action associated with an execution context that results in a resource conflict. The identifying 48 may be a complicated process, because the user action may have generated the request through various other objects or interfaces, such as an application programming interface configured to access the protected resource. By performing the identifying 48 only for user actions that issue requests that generate resource conflicts, the exemplary method 40 may thereby conserve computing resources by avoiding additional identifying 48 for routine requests that might not produce useful information. Additionally, the identifying may be easier to perform if the execution context is in a static state than if the execution context continues to execute (e.g., if the user action comprises an instruction in the code, the instruction pointer may not point to the conflict-generating instruction if the execution context continues to run while it is examined.) If the request is a synchronous, blocking request, the execution context generating the request is already stopped and pending the fulfillment of the request, so the identifying 48 may be easier to perform for these stopped execution contexts than for other execution contexts that continue to execute. However, the identifying 48 may be performed according to various techniques. As a first example, execution contexts may include an execution context identifier and/or a user action identifier (e.g., a unique identifier assigned to a user action detected through a user interface, such as a sixth clicking of a particular button, or the instruction referenced by the instruction pointer of an identified execution context) as part of each request, so that these techniques may simply review the contents of the request to identify the execution context. However, this first example may involve redesigning the request communication protocol, which may not be feasible on many systems. As a second example, the computing environment may associate each request with a user action associated with an execution context before processing it against a resource; however, this technique may involve additional computing environment overhead that may otherwise diminish system performance. As a third example, the identifying 48 may comprise performing a stack walk to identify the execution context issuing the request for the resource, and the user action executed within the execution context that raised the request. This example mitigates system redesign and additional computing environment overhead for requests that do not generate resource conflicts, and may therefore be advantageous. Those of ordinary skill in the art may devise many ways to identify an execution context that initiated a resource-conflict-generating request while implementing the techniques discussed herein.

A fourth aspect that may vary among implementations of these techniques relates to the role of the embodiment in the computing environment, and in particular with respect to the protected resource and requests made thereto. In this aspect, an embodiment of these techniques may participate, to varying degrees, in the mechanism of requesting and granting access to the protected resource. At least two interaction models may be devised for embodying the techniques in the computing environment: a passive model, wherein the techniques are applied to listen to the pattern of requests and responses; and an active model, wherein the techniques are implemented within an interface to the protected resource.

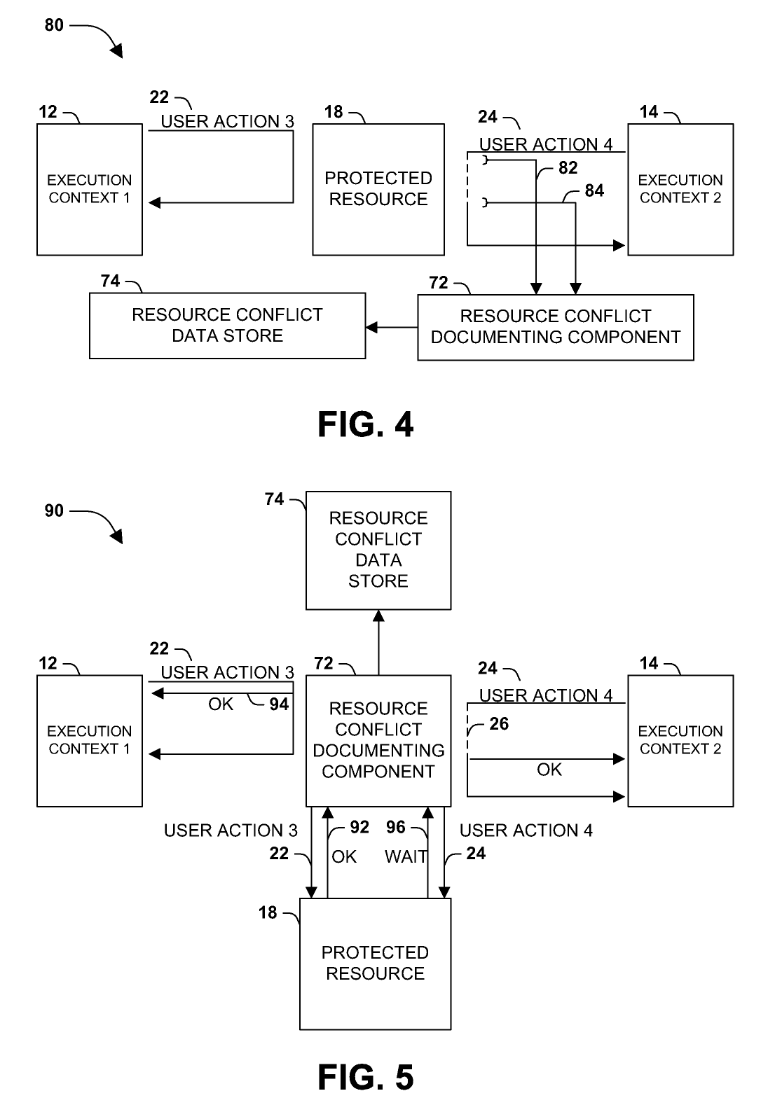

FIG. 4 illustrates a passive model in a scenario 80 that again involves a first execution context 12 and a second execution context 14 that concurrently utilize a protected resource 16 through a third user action 22 that is granted, and a fourth user action 24 that causes a resource conflict. In this illustration of a passive model, the computing environment is configured to detect and report resource conflicts in an event subscription model, and to raise two types of events: a resource conflict event, which occurs when a request to a protected resource 16 generates a resource conflict, and a resource conflict resolution event, which occurs when a resource conflict is ameliorated. An embodiment of these techniques, comprising a resource conflict documenting component 72 and a resource conflict data store 74, may be configured to detect resource conflicts and the resolution thereof by subscribing to these events and receiving notifications from the computing environment. For instance, when the second execution context 14 executes the fourth user action 24 that generates a resource conflict with respect to the protected resource 16, the computing environment may generate a resource conflict event notification 82 and deliver it to the resource conflict documenting component 72, which may begin documenting the resource conflict (e.g., and as illustrated in FIG. 2, by storing 46 a request time and identifying 48 the second execution context 14 and the fourth user action 24 that caused the resource conflict, e.g., by performing a stack walk.) Similarly, when the resource conflict is resolved, the computing environment may generate a resource conflict resolution event notification 84 and delivering it to the resource conflict documenting component 72, which may complete the documenting of the resource conflict (e.g., and again as illustrated in FIG. 2, by calculating 52 the resource conflict duration and documenting 54 the resource, the execution context, and the resource conflict duration, such as by storing these items as a record in the resource conflict data store 74.) Accordingly, the embodiment exists as a passive observer of system activity, and may detect and observe the interaction of execution contexts and resources without interfering with the behavior or the performance thereof.

By contrast, FIG. 5 illustrates an active model, wherein the techniques discussed herein are intertwined with the mechanism for receiving and processing requests by execution contexts for access to the protected resource 16. FIG. 5 illustrates a scenario 90 wherein the techniques are implemented as an interface wrapping the protected resource 16, such that execution contexts submit requests for access to the protected resource 16 to the resource conflict documenting component, which negotiates such requests with the protected resource 16 and reports the results to the execution contexts. Thus, the embodiment not only documents the flow of requests and responses, but also brokers and proves access to the protected resource 16 to various execution contexts.

As illustrated in FIG. 5, the first execution context 12 may submit the third request 22 to the resource conflict documenting component 72, which may forward the third request 22 to the protected resource 16. Because the protected resource 16 is not in conflicting use at the time of the third request 22, the protected resource 16 may grant the third request 22, e.g., with an “OK” response 92 (such as may be generated by a monitor.) The resource conflict documenting component 72 may receive the “OK” response 92 and may promptly respond to the first execution context 12 with an authorization 94 of the granted access to the protected resource 16. Thus, an embodiment of the technique may, upon detecting availability of the resource without a resource conflict, provide the resource to the execution context that requested access. However, when the second execution context 14 executes the fourth user action 24 and submits a request to the resource conflict documenting component 72, the resource conflict documenting component 72 submits the request to the protected resource 16 but receives back a “WAIT” response 96, due to the exclusive access granted to the first execution context 12 at the time of the fourth user action 24, thereby indicating a resource conflict. In this case, the resource conflict documenting component 72 may handle the resource conflict in many ways. As illustrated in FIG. 5, the resource conflict documenting component may handle the request synchronously by simply blocking the second execution context 14 for the duration of the delay period 26, until access is granted by the protected resource 16. When the resource conflict documenting component 72 subsequently detects the availability of the protected resource 16 after the resource conflict, the resource conflict documenting component 72 may unblock the second execution context 14 and provide access to the protected resource 16. In another variation, the resource conflict documenting component 72 may handle such requests asynchronously, e.g., by arranging to allow the second execution context 14 to continue processing during the delay period 26 (without being permitted to access the protected resource 16) and to notify the second execution context 14 when the protected resource 16 is available. For example, upon receiving the request by an execution context to access the protected resource 16, the resource conflict documenting component 72 may receive from the execution context a resource request callback, and the provision of the protected resource 16 to the execution context may involve invoking the resource request callback of the execution context to notify it of the availability of the resource. Those of ordinary skill in the art may be able to devise many roles for the techniques discussed herein in the requesting and granting of access by execution contexts to protected resources.

A fifth aspect that may vary among implementations of these techniques relates to the manner of recording the duration of the resource conflict induced by the request for access to the resource. As a first example, the protected resource may indicate the duration of a resource conflict generated by a particular request as part of its acknowledgment of the fulfillment of the request. As a second example, if the computing environment is configured to detect and report resource conflicts (e.g., as part of a subscription model or an event log), the computing environment may also track and report the duration of the resource conflict for a particular request. As a third example, illustrated with reference to FIG. 3, upon detecting a request 64 to use the protected resource 16, an embodiment of these techniques (such as the exemplary system 68) may be configured to record the request time; and upon detecting the availability of the protected resource 16 after the resource conflict, the embodiment may be configured to subtract the stored request time from the current time to calculate the resource conflict duration 66. In an exemplary system 68, this timing calculation may be performed by a resource conflict duration calculating component. As a fourth example, again illustrated with reference to FIG. 3, an embodiment of these techniques (such as the exemplary system 68) may include a resource conflict duration timer, such as a hardware or interrupt-driven software timer that measures a duration. Upon detecting a resource conflict over a protected resource 16 generated by a request 64, the embodiment may initiate the resource conflict duration timer at zero, and upon detecting the availability of the protected resource 16 for the request 64, the embodiment may sample the resource conflict duration timer to calculate the resource conflict duration 66. Those of ordinary skill in the art may be able to devise many ways of measuring the duration of a resource conflict while implementing the techniques discussed herein.

A sixth aspect that may vary among implementations relates to the manner of recording to resource conflict. As a first example, the resource conflict may be recorded in an event log, e.g., as a text entry describing the details of the resource conflict. As a second example, the resource conflict may be recorded by generating a resource conflict object containing the details of the resource conflict, which may be stored (in either a transitory or persistent manner) in a specialized object store or delivered to the execution context or a monitoring process. As a third example, such as in the exemplary method 40 of FIG. 2, the documenting 54 may comprise creating a resource conflict record comprising the resource, the user action executed by the execution context, and the resource conflict duration. This resource conflict record may be stored, e.g., in a resource conflict data store 28, such as illustrated in FIG. 1. Those of ordinary skill in the art may be able to devise many ways of recording the resource conflict while implementing the techniques discussed herein.

These variations of these aspects may be included in many embodiments of the techniques discussed herein, including the exemplary method 40 of FIG. 2 and the exemplary system 68 of FIG. 3. Moreover, several such variations may be implemented in combination, and with other variations of these and other aspects of these techniques, to provide several advantages and/or reduce disadvantages with respect to the more basic embodiments illustrated in FIGS. 3-4.

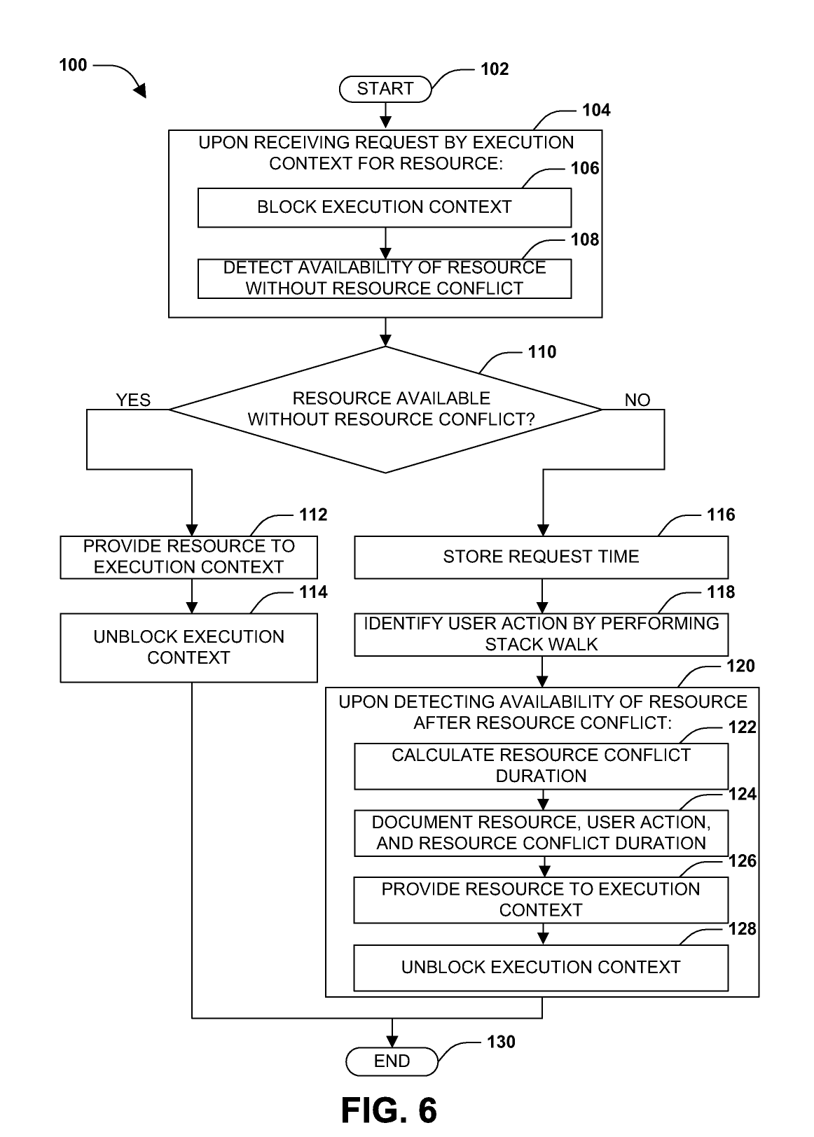

FIG. 6 illustrates one such embodiment that features many variations in the aspects discussed herein. This illustration presents an exemplary method 100 of documenting a resource conflict relating to a resource. The resource to which this exemplary method 100 may be applied is shared by at least two execution contexts by a an access sharing construct, e.g., at least one of a semaphore, a critical section, and a monitor. Within this computing environment, the exemplary method 100 is configured to document the incidence of resource conflicts generated by access requests from various execution contexts. This exemplary method 100 is also devised according to an active and synchronous model, such as illustrated in FIG. 5.

The exemplary method 100 begins at 102 and at the receipt of a request by an execution context for access to a resource. Upon receiving 104 a request by the execution context for the resource, the exemplary method 100 handles the request synchronously by first blocking 106 the execution context. The exemplary method 100 then detects 108 the availability of the resource without a resource conflict, e.g., by querying the resource through an “IsAvailable( )” query method. The exemplary method 100 then branches at 110 depending on the result of the availability detection. If the resource is currently available without a resource conflict, the exemplary method 100 branches at 110 and involves providing 112 the resource to the execution context and unblocking 114 the execution context, after which the exemplary method 100 ends at 130. However, if the resource is not currently available, then a resource conflict exists. In this case, the exemplary method 100 branches at 110 and involves storing 116 a request time and identifying 118 the user action within the execution context by performing a stack walk to identify the user action executed by the execution context issuing the request for the resource. The exemplary method 100 then awaits the resolution of the resource conflict (e.g., by polling the resource to determine renewed availability, by receiving an asynchronous callback notification from the resource, by receiving a notification through an event log or resource conflict resolution event subscription, etc.) Upon detecting 120 the availability of the resource after the resource conflict, the exemplary method 100 involves calculating 122 a resource conflict duration and documenting 124 the resource conflict, e.g., by creating a resource conflict record in a resource conflict data store identifying the resource, the user action that caused the resource conflict, and the resource conflict duration. The exemplary method 100 then involves providing 126 the resource to the execution context and unblocking 128 the execution context, wherein the exemplary method ends at 130. By handling requests for access to the protected resource in an active manner, the exemplary method 100 thereby brokers access to the protected resource on behalf of various execution contexts in a synchronous manner while also documenting the pattern of resource conflicts, which may be useful for developers in reconfiguring the execution contexts and/or the resource to reduce usage bottlenecks and to improve the performance of the applications and resources.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, an execution context, a program, and/or a computer. By way of illustration, both an application running on a controller and the controller can be a component. One or more components may reside within a process and/or execution context of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

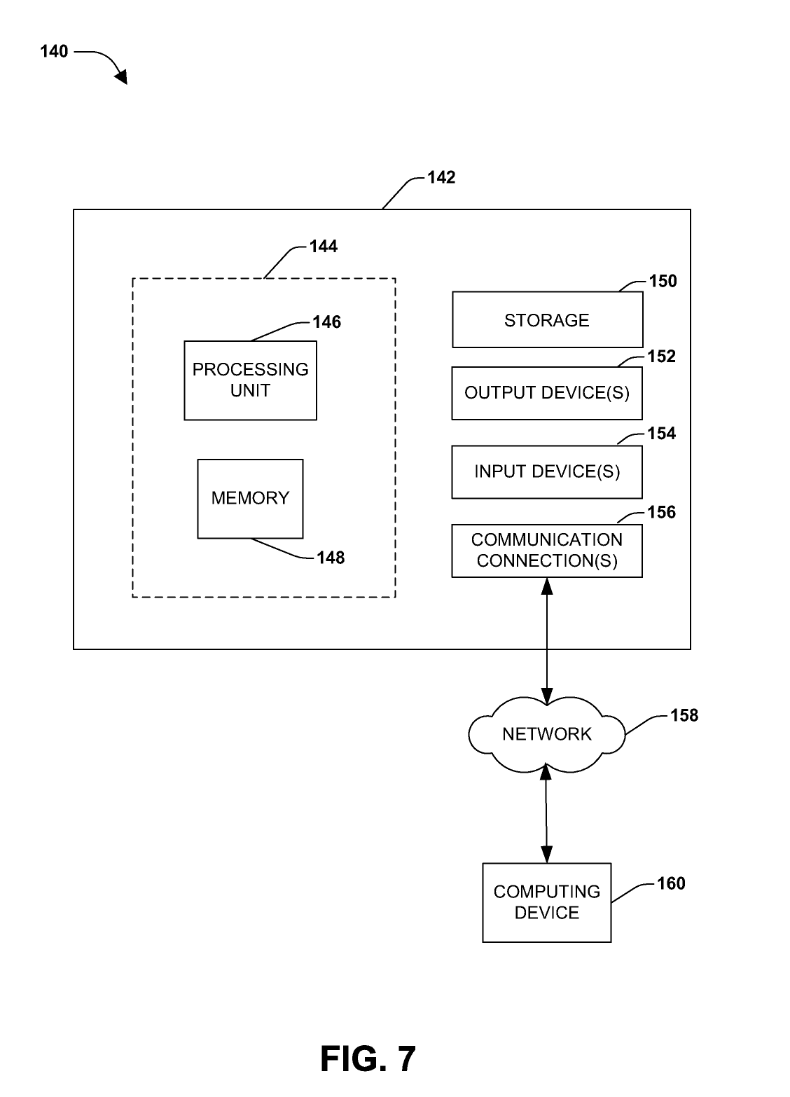

FIG. 7 and the following discussion provide a brief, general description of a suitable computing environment to implement embodiments of one or more of the provisions set forth herein. The operating environment of FIG. 7 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 7 illustrates an example of a system 140 comprising a computing device 142 configured to implement one or more embodiments provided herein. In one configuration, computing device 142 includes at least one processing unit 146 and memory 148. Depending on the exact configuration and type of computing device, memory 148 may be volatile (such as RAM, for example), non-volatile (such as ROM, flash memory, etc., for example) or some combination of the two. This configuration is illustrated in FIG. 7 by dashed line 144.

In other embodiments, device 142 may include additional features and/or functionality. For example, device 142 may also include additional storage (e.g., removable and/or non-removable) including, but not limited to, magnetic storage, optical storage, and the like. Such additional storage is illustrated in FIG. 7 by storage 150. In one embodiment, computer readable instructions to implement one or more embodiments provided herein may be in storage 150. Storage 150 may also store other computer readable instructions to implement an operating system, an application program, and the like. Computer readable instructions may be loaded in memory 148 for execution by processing unit 146, for example.

The term “computer readable media” as used herein includes computer storage media. Computer storage media includes volatile and nonvolatile, removable and non-removable media implemented in any method or technology for storage of information such as computer readable instructions or other data. Memory 148 and storage 150 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 142. Any such computer storage media may be part of device 142.

Device 142 may also include communication connection(s) 156 that allows device 142 to communicate with other devices. Communication connection(s) 156 may include, but is not limited to, a modem, a Network Interface Card (NIC), an integrated network interface, a radio frequency transmitter/receiver, an infrared port, a USB connection, or other interfaces for connecting computing device 142 to other computing devices. Communication connection(s) 156 may include a wired connection or a wireless connection. Communication connection(s) 156 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 142 may include input device(s) 154 such as keyboard, mouse, pen, voice input device, touch input device, infrared cameras, video input devices, and/or any other input device. Output device(s) 152 such as one or more displays, speakers, printers, and/or any other output device may also be included in device 142. Input device(s) 154 and output device(s) 152 may be connected to device 142 via a wired connection, wireless connection, or any combination thereof. In one embodiment, an input device or an output device from another computing device may be used as input device(s) 154 or output device(s) 152 for computing device 142.

Components of computing device 142 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 142 may be interconnected by a network. For example, memory 148 may be comprised of multiple physical memory units located in different physical locations interconnected by a network.

Those skilled in the art will realize that storage devices utilized to store computer readable instructions may be distributed across a network. For example, a computing device 160 accessible via network 158 may store computer readable instructions to implement one or more embodiments provided herein. Computing device 142 may access computing device 160 and download a part or all of the computer readable instructions for execution. Alternatively, computing device 142 may download pieces of the computer readable instructions, as needed, or some instructions may be executed at computing device 142 and some at computing device 160.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of documenting a resource conflict relating to a resource, the method comprising:
upon detecting a request by an execution context for the resource resulting in a resource conflict:
storing a request time, and
identifying a user action associated with the execution context that caused the resource conflict; and
upon detecting availability of the resource after the resource conflict:
calculating a resource conflict duration, and
documenting the resource, the user action, and the resource conflict duration.

2. The method of claim 1, the request comprising one of:
a synchronous blocking resource request, and
an asynchronous non-blocking resource request.

3. The method of claim 1, the resource shared among at least two execution contexts by an access sharing construct.

4. The method of claim 3:
the resource conflict comprising a request for the resource by the execution context during a resource access by a second execution context; and
the availability comprising a completion of the resource access by the second execution context.

5. The method of claim 3, the access sharing construct comprising at least one of: a semaphore, a critical section, and a monitor.

6. The method of claim 1, the identifying comprising:
performing a stack walk to identify the execution context issuing the request for the resource, and
identifying the user action associated with the execution context identified by the stack walk that caused the resource conflict.

7. The method of claim 1:
the method comprising: subscribing to a resource conflict event;
detecting the request comprising: receiving a resource conflict event notification; and
detecting the availability comprising: receiving a resource conflict resolution event notification.

8. The method of claim 1, comprising:
upon receiving a request by the execution context for the resource:
detecting availability of the resource, and
upon detecting availability of the resource without a resource conflict, providing the resource to the execution context; and
upon detecting the availability of the resource after the resource conflict, providing the resource to the execution context.

9. The method of claim 8, comprising:
upon detecting the request, blocking the execution context; and
upon detecting the availability of the resource after the resource conflict, unblocking the execution context.

10. The method of claim 8, comprising:
upon detecting the request by the execution context for the resource, receiving from the execution context a resource request callback; and
the providing comprising: invoking the resource request callback of the execution context.

11. The method of claim 1, the documenting comprising: creating a resource conflict record in a resource conflict data store, the resource conflict record comprising the resource, the user action, and the resource conflict duration.

12. A system for documenting resource conflicts relating to at least one resource, the system comprising:
a resource conflict data store configured to store records of resource conflicts involving a resource, an execution context requesting the resource resulting in a resource conflict, and a resource conflict duration; and
a resource conflict documenting component configured to:
upon detecting a request by an execution context for a resource resulting in a resource conflict:
store a request time, and
identify the execution context; and
upon detecting availability of the resource after the resource conflict:
calculate a resource conflict duration, and
create a resource conflict record in the resource conflict data store.

13. The system of claim 12, the resource conflict documenting component comprising:
a stack walking component configured to:
identify the execution context issuing the request for the resource, and
identify the user action associated with the execution context identified by the stack walk that caused the resource conflict.

14. The system of claim 12, the resource conflict documenting component comprising:
a resource conflict identifying component configured to:
subscribe to a resource conflict event;
detect the request by receiving a resource conflict event notification; and
detect the availability by receiving a resource conflict resolution event notification.

15. The system of claim 12, comprising:
a resource request handling component configured to:
upon receiving a request by the execution context for the resource:
detect availability of the resource, and
upon detecting availability of the resource without a resource conflict, provide the resource to the execution context; and
upon detecting the availability of the resource after the resource conflict, provide the resource to the execution context.

16. The system of claim 15, the resource request handling component configured to:
upon detecting the request, block the execution context; and
upon detecting the availability of the resource after the resource conflict, unblock the execution context.

17. The system of claim 15, the resource request handling component configured to:
upon detecting the request by the execution context for the resource, receive from the execution context a resource request callback; and
provide the resource to the execution context by invoking the resource request callback of the execution context.

18. The system of claim 12, the resource conflict documenting component comprising:
a resource conflict duration calculating component configured to:
upon detecting the request, store a resource availability time; and
upon detecting the availability of the resource after the resource conflict, subtract the request time from the resource availability time.

19. The system of claim 12:
the resource conflict documenting component comprising a resource conflict duration timer, and
the resource conflict documenting component configured to:
upon detecting the request, initiate the resource conflict duration timer; and
upon detecting the availability of the resource after the resource conflict, calculate the resource conflict duration according to the resource conflict duration timer.

20. A method of documenting a resource conflict relating to a resource shared by at least two execution contexts by an access sharing construct comprising at least one of a semaphore, a critical section, and a monitor, the method comprising:
upon receiving a request by the execution context for the resource:
blocking the execution context;
detecting availability of the resource, and
upon detecting availability of the resource without a resource conflict:
providing the resource to the execution context, and
unblocking the execution context;
upon detecting a synchronous blocking resource request by an execution context for the resource resulting in a resource conflict:
storing a request time, and
performing a stack walk to identify the execution context issuing the request for the resource, and
identifying the user action associated with the execution context identified by the stack walk that caused the resource conflict; and
upon detecting availability of the resource after the resource conflict:
calculating a resource conflict duration;
documenting the resource, the user action, and the resource conflict duration by creating a resource conflict record in a resource conflict data store, the resource conflict record comprising the resource, the execution context, and the resource conflict duration;
providing the resource to the execution context; and
unblocking the execution context.
